(19) United States
(12) Patent Application Publication
(10) Pub. No.: US 2010/0139828 A1
(43) Pub. Date: Jun. 10, 2010

(54) Vehicle Tire That Automatically Replenishes Air Pressure

(75) Inventor: Soo Hyuk LEE, Seoul (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/482,228

(22) Filed: Jun. 10, 2009

(30) Foreign Application Priority Data
Dec. 5, 2008 (KR) 10-2008-0123438

(51) Int. Cl. B60C 23/10

(52) U.S. Cl. 152/426

(57) ABSTRACT

A vehicle tire that automatically replenishes air pressure is described. The vehicle tire includes a tire portion that surrounds a wheel and is filled with air, and an air pressure replenishing member that is arranged at the inside of the tire portion and coupled with a portion of the outer surface of the wheel to replenish the air pressure when the air pressure in the tire portion is low. The vehicle tire may automatically replenish the air pressure when the air pressure in the tire portion is too low by the air pressure replenishing member, and thus fuel efficiency and driving performance of the vehicle may be maintained at a constant level.

### CROSS-REFERENCE TO RELATED APPLICATION

The present application claims priority to Korean Patent Application Number 10-2008-0123438 filed Dec. 5, 2008, the entire contents of which application is incorporated herein for all purposes by this reference.

### BACKGROUND OF THE INVENTION

1. Field of the Invention

The present invention relates to a vehicle tire that automatically replenishes air pressure, and more specifically, to a vehicle tire that automatically replenishes air pressure to prevent problems such as lowered fuel efficiency and impaired driving performance which may result when the air pressure in the tire decreases due to road conditions.

2. Description of Related Art

A tire is an essential component of a vehicle. The tire is filled with air to a predetermined air pressure to support the weight of the vehicle.

Recently, a device known as a TPMS (Tire Pressure Monitoring System) has been provided in the tire to monitor the air pressure in the tire. The TPMS enables the vehicle driver to determine when the air pressure in the tire is low in order to replenish it.

However, while the TPMS can measure the air pressure in the tire, it cannot replenish the air pressure when it is too low.

When a vehicle is driven with low tire pressure for an extended period of time, driving performance and stability are reduced, and a traffic accident may occur.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a tire that has a replenishing member that can sense when the air pressure in the tire is low and automatically replenish the low air pressure. In this case, the air pressure in the tire is replenished using external air.

The replenishing member may operate only while the air pressure in the tire is low and not while the air pressure in the tire is appropriate.

In an aspect of the present invention, a vehicle tire that automatically replenishes air pressure, the vehicle tire may include a tire portion that surrounds a wheel and is filled with air, and an air pressure replenishing member that is arranged at the inside of the tire portion and connected to the wheel to selectively replenish air into the tire portion from the outside thereof, wherein the air pressure replenishing member includes a plurality of fluid control members that are provided at the wheel and at the inside of the tire portion to control air flow from the outside of the wheel into the tire portion, and an air pressure check cylinder unit that is connected to the fluid control members and located in the tire portion and configured to activate or deactivate the fluid control member according to pressure difference between the inside of the tire portion and the outside thereof.

The fluid control members may include a first fluid control member connected to the wheel and the air pressure check cylinder unit to control the air flow into the tire portion, and a second fluid control member connected to the air pressure check cylinder unit in the tire portion to control air flow in the air pressure check cylinder unit into the tire portion.

The first fluid control member may include a pipe having an inlet/outlet hole structure through which air enters/exits the pipe, an elastic body that is provided at a portion of the inside of the pipe, and a sealing ball that is biased by the elastic body to an inlet hole to permit one-way air flow from the inlet hole to an outlet hole if air pressure outside the tire portion is higher than air pressure inside the tire portion, wherein the inlet hole is connected to the outside of the wheel and the outlet hole is connected to the inside of the air pressure check cylinder unit, wherein the outlet of the inlet/outlet hole structure is formed as a plurality of outlet holes.

The second fluid control member may include a pipe having an inlet/outlet hole structure through which air enters/exits the pipe, an elastic body that is provided at a portion of the inside of the pipe, and a sealing ball that is biased by the elastic body to an inlet hole to permit one-way air flow from the inlet hole to an outlet hole if the air pressure outside the tire portion is higher than the air pressure inside the tire portion, wherein the inlet hole is connected to the air pressure check cylinder unit and the outlet hole is connected to the inside of the tire portion, wherein the outlet of the inlet/outlet hole structure is formed as a plurality of outlet holes.

The air pressure check cylinder unit may include a cylinder connected to the outlet hole of the first fluid control member and the inlet hole of the second fluid control member, a piston slidably inserted into the cylinder to move back and forth inside the cylinder, and a return spring disposed in the cylinder and selectively compressed by the piston, wherein the piston includes a pushrod that extends outwards from the cylinder, and a pushrod end that extends from an end of the pushrod and abuts the inner surface of the tire portion with a predetermined distance in a normal state to check the air pressure in the tire portion.

In another aspect of the present invention, the fluid control member may include a pipe having an inlet/outlet hole structure through which air enters/exits the pipe, an elastic body that is provided at a portion of the inside of the pipe, and a sealing ball that is biased by the elastic body to an inlet hole to permit one-way air flow from the inlet hole to an outlet hole if the air pressure outside the tire portion is higher than the air pressure in the tire portion, wherein at least one of the fluid control members includes an inlet hole connected to the outside of the wheel and an outlet hole connected to the air pressure check cylinder, and wherein at least one of the fluid control members includes an inlet hole connected to the air pressure check cylinder unit and an outlet hole connected to the inside of the tire portion, wherein the outlet of the inlet/outlet hole structure is formed as a plurality of outlet holes and wherein the outlet of the inlet/outlet hole structure is formed as a plurality of outlet holes.

The vehicle tire according to the present invention, which is configured as above to automatically replenish the air pressure, has the air pressure replenishing member that is provided at the inside of the tire and coupled to a portion of the wheel. When the air pressure in the tire is too low, the air pressure replenishing member automatically replenishes the air pressure.

Since the air pressure replenishing member automatically replenishes the air pressure when it becomes too low, vehicle fuel efficiency and driving performance can be maintained at a constant level.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating a tire provided with an exemplary air pressure replenishing member according to the present invention.

FIG. 2 is a cross-sectional view illustrating in detail the air pressure replenishing member according to the present invention.

FIG. 3A is a cross-sectional view illustrating in detail an exemplary fluid control member according to the present invention.

FIG. 3B is a cross-sectional view illustrating in detail the fluid control member according to the present invention.

FIG. 4A is a view illustrating the air pressure replenishing member when the tire has appropriate air pressure.

FIG. 4B is a view illustrating the air pressure replenishing member when the tire has lower than appropriate tire pressure.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

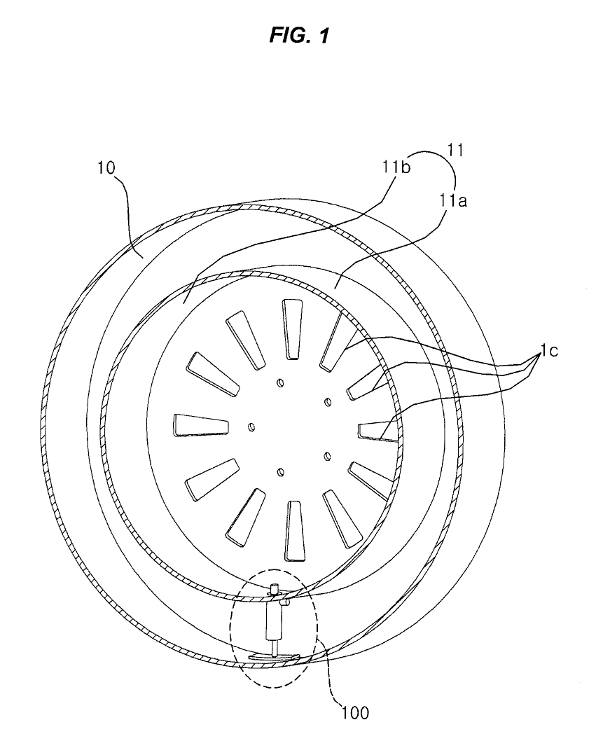

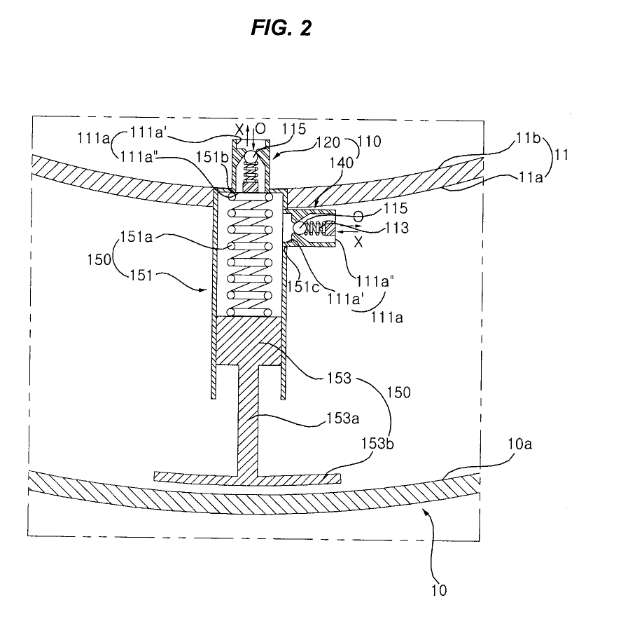

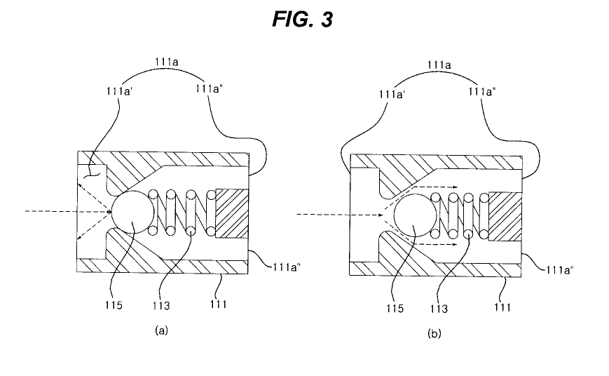

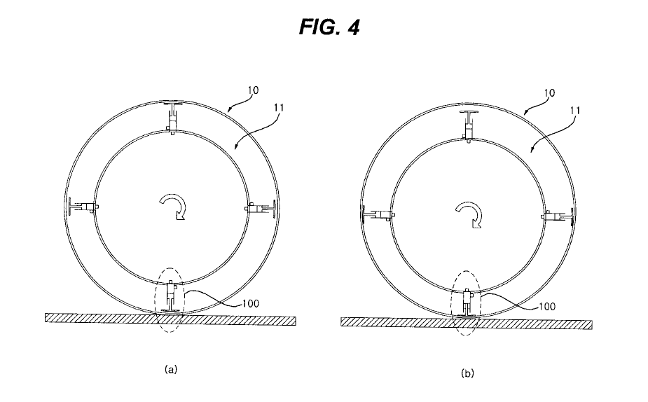

FIG. 1 is a perspective view illustrating a tire provided with an air pressure replenishing member according to various embodiments of the present invention. FIG. 2 is a cross-sectional view illustrating in detail the air pressure replenishing member according to various embodiments of the present invention. FIG. 3A is a cross-sectional view illustrating in detail a fluid control member according to various embodiments of the present invention. FIG. 3B is a cross-sectional view illustrating in detail a fluid control member according to various embodiments of the present invention. FIG. 4A is a view illustrating the air pressure replenishing member when the tire has appropriate air pressure. FIG. 4B is a view illustrating the air pressure replenishing member when the tire has lower than appropriate tire pressure.

Referring to FIGS. 1 to 4, the vehicle tire according to various embodiments of the present invention, which automatically replenishes air pressure, includes a tire portion 10 that surrounds the outer surface of a wheel 11 and is filled with air to support the weight of the vehicle; and an air pressure replenishing member 100 that is arranged at the inside of the tire portion 10, coupled with a portion of the outer surface 11a of the wheel 11, and replenishes the air pressure in the tire portion 10 using external air when the air pressure in the tire portion 10 is too low.

The air pressure replenishing member 100 includes a plurality of fluid control members 110 that are arranged at a portion of the wheel 11 and at the inside of the tire portion 10 to control the flow of external air and air in the tire; and an air pressure check cylinder unit 150 that is coupled with the fluid control members 110, located at the inside of the tire portion 10, and checks the air pressure in the tire portion 10.

The fluid control members 110 include a first fluid control member 120 that is coupled with a portion of the inner surface 11b of the wheel 11 to control the flow of external air into the tire portion 10; and a second fluid control member 140 that is connected to the air pressure check cylinder unit 150 and arranged at the inside of the tire portion 10 to control the flow of air from the inside of the tire portion 10 to the outside.

Each of the fluid control members 110 includes a pipe 111 that is integrally formed with an inlet/outlet hole structure 111a through which air may enter/exit the pipe 111; an elastic body 113 that is provided at the inside of the pipe 111 and coupled with a portion of the pipe 111; and a sealing ball 115 that is connected to the elastic body 113 to seal the inlet 111a′ of the inlet/outlet hole structure 111a.

Also, the inlet 111a′ of the inlet/outlet hole structure 111a may be formed as a single hole, and the outlet 111a″ of the inlet/outlet hole structure 111a may be formed as a plurality of holes.

The air pressure check cylinder unit 150 is coupled with a portion of the outer surface 11a of the wheel 11. The air pressure check cylinder unit 150 includes a cylinder 151 that is connected to the first fluid control member 120 and has a return spring 151a therein; and a piston 153 that is inserted into the cylinder 151 to move back and forth.

A pushrod 153a extends from one end of the piston 153 outward from the cylinder 151, and a pushrod end 153b extends from an end of the pushrod 153a to abut the inner surface 10a of the tire portion 10 so that the air pressure in the tire portion 10 may be checked.

In the first fluid control member 120, the outlet 111a″ of the pipe 111 is connected to an end of the cylinder 151, and in the second fluid control member 140 the inlet 111a′ of the pipe 111 is connected to the outer surface 151b of the cylinder 151.

The cylinder 151 has through holes 151b and 151c near where the fluid control members 120 and 140 are connected, respectively, so that the external air and the air in the tire portion 10 may enter/exit the inside of the cylinder 151 through the first fluid control member 120 and the second fluid control member 140.

The structure of the present invention configured as above will now be described in more detail.

The circular wheel 11 has a plurality of holes 1c through which the external air may flow in/out. The tire portion 10 surrounding the outer surface 11a of the wheel 11 is filled with air with enough pressure to support the weight of the vehicle.

Also, the distance between the wheel 11 and an outer portion of the tire contacting the ground becomes shorter than the distance between the wheel 11 and the other outer portions of the tire due to the weight of the vehicle.

Meanwhile, the tire portion 10 may have lower than appropriate air pressure due to various factors during driving.

If the air pressure in the tire portion 10 is too low, fuel efficiency and driving performance are lowered, and thus a traffic accident may occur. Therefore, the air pressure replenishing member 100 is arranged at the inside of the tire portion 10 and coupled with a portion of the outer surface 11a of the wheel 11 to automatically replenish the air pressure when the air pressure in the tire portion 10 is too low.

The air pressure replenishing member 100 is initially located at a portion of the tire portion 10 which contacts the ground.

First, the fluid control members 110 are provided at the inside of the wheel 11 and the tire portion 10. The first fluid control member 120 is coupled with the inner surface 11b of the wheel 11 and the second fluid control member 140 is provided at the inside of the tire portion 10.

Each of the fluid control members 110 has a pipe 111 that is integrally formed with the inlet/outlet hole structure 111a through which air enters/exits the pipe 111, wherein the inlet 111a′ may be formed as a hole and the outlet 111a″ may be formed as a plurality of holes.

An elastic body 113 is coupled at the outlet 111a″, and a sealing ball 115 is coupled with the elastic body 113 at the inlet 111a′ to seal the inlet 111a′.

The fluid control members 110 are configured so that air flows only in the direction from the inlet 111a′ to the outlet 111a″. Since the sealing ball 115 that seals the inlet 111a′ is connected to the elastic body 113 that is coupled at the outlet 111a″, the inlet 111a′ may be opened only by air pressure.

In the first fluid control member 120 configured as above, the outlet 111a″ is coupled with the inner surface 11b of the wheel 11.

The air pressure check cylinder unit 150, which is connected to the first fluid control member 120 and provided at the inside of the tire portion 10, is coupled with the outer surface 11a of the wheel 11.

A hole 151b is provided at an end of the cylinder 151 that has the return spring 151a therein. The first fluid control member 120 is coupled at the hole 151b of the cylinder 151 and the piston 153 is inserted into the cylinder through the other end of the cylinder 151.

The pushrod 153a extends from the piston 153 outward from the cylinder 151 at the inside of the tire portion 10, and the pushrod end 153b extends from an end of the pushrod 153a to be capable of abutting the inner surface 10a of the tire portion 10.

When the air pressure in the tire portion 10 is appropriate, the pushrod end 153b does not contact the inner surface 10a of the tire portion 10.

Meanwhile, the second fluid control member 140 connected to the air pressure check cylinder unit 150 is provided at the inside of the tire portion 10. The hole 151c is provided at an outer portion of the cylinder 151 and the second fluid control member 140 is coupled at the hole 151c.

Operation of the vehicle tire with the above structure, which automatically replenishes air pressure, will be described below.

In the air pressure replenishing member 100 that automatically replenishes the air pressure in the tire portion 10 when it becomes too low, the pushrod end 153b is separated from the inner surface 10a of the tire portion 10 while the air pressure in the tire is appropriate, as can be seen in FIG. 2.

That is, when the tire portion 10 maintains appropriate air pressure during driving, the air pressure replenishing member 100 rotates at the inside of the tire portion 10 without contacting the inner surface 10a of the tire portion 10, as shown in FIG. 4A.

When the air pressure in the tire portion 10 becomes lower than appropriate due to various factors during driving, the pushrod end 153b contacts the inner surface 10a of the tire when the part of the tire where the air pressure replenishing member 100 is provided contacts the ground.

When the pushrod end 153b contacts the inner surface 10a of the tire portion 10, a force exerted against the ground forces the pushrod 153a extending from the pushrod end 153b and the piston 153 to move in the cylinder 151.

The piston 153 moves up in the cylinder 151 to pressurize the return spring 151a, so that the pressure in the cylinder 151 is increased.

The increased pressure in the cylinder 151 operates the second fluid control member 140 that is coupled with the outer portion of the cylinder 151 and provided at the inside of the tire portion 10.

When a push force is exerted against the sealing ball 115 that seals the inlet 111a′ of the second fluid control member 140 by the increased pressure in the cylinder 151, the sealing ball 115 opens the inlet 111a′ and the air compressed in the cylinder 151 flows from the inlet 111a′ to the outlet 111a″ to enter into the tire portion 10 as shown in FIG. 3B.

When the air in the cylinder 151 enters into the tire portion 10, the pressure in the cylinder 151 is low so that the sealing ball 115 of the second fluid control member 140 is brought to seal the inlet 111a′ again by the elastic body 113.

The above operation is repeated while the part of the tire portion 100 where the air pressure replenishing member 100 is provided contacts the ground, and when the part of the tire portion 100 where the air pressure replenishing member 100 is provided is off the ground due to the rotation of the tire portion 10 during driving, the piston 153 is returned to its original location by the return spring 151a.

At this time, because the air pressure in the cylinder 151 is lower than the external air pressure, the sealing ball 115 that seals the inlet 111a′ of the first fluid control member 120 opens the inlet 111a′ by the external air pressure and the external air passes from the inlet 111a′ through the outlet 111a″ into the cylinder 151.

When the air pressure in the cylinder 151 becomes higher than the external air pressure due to the entering air, the first fluid control member 120 is sealed and the part of the tire portion 10 where the air pressure replenishing member 100 is provided contacts the ground again, so that the pushrod 153b doe not contact the tire 10.

The above operation is repeated while the tire portion 10 rotates during driving, and this may automatically replenish the air pressure in the tire portion 10.

In the vehicle tire having the air pressure replenishing member 100, when the air pressure in the tire portion 10 becomes too low due to various factors, it may be promptly replenished by the air pressure replenishing member 100 using external air. Therefore, lowering of vehicle fuel efficiency and driving performance may be effectively prevented.

As described above, since the vehicle tire automatically replenishes air pressure that has become too low during driving to an appropriate level by supplying external air to the inside of the tire, the vehicle tire can prevent lowering of vehicle fuel efficiency and driving performance, thus helping to prevent traffic accidents.

For convenience in explanation and accurate definition in the appended claims, the terms “upper”, “lower”, “inner”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle tire that automatically replenishes air pressure, the vehicle tire comprising:
a tire portion that surrounds a wheel and is filled with air; and
an air pressure replenishing member that is arranged at the inside of the tire portion and connected to the wheel to selectively replenish air into the tire portion from the outside thereof,
wherein the air pressure replenishing member includes:
a plurality of fluid control members that are provided at the wheel and at the inside of the tire portion to control air flow from the outside of the wheel into the tire portion; and
an air pressure check cylinder unit that is connected to the fluid control members and located in the tire portion and configured to activate or deactivate the fluid control member according to pressure difference between the inside of the tire portion and the outside thereof.

2. The vehicle tire of claim 1, wherein the fluid control members include:
a first fluid control member connected to the wheel and the air pressure check cylinder unit to control the air flow into the tire portion; and
a second fluid control member connected to the air pressure check cylinder unit in the tire portion to control air flow in the air pressure check cylinder unit into the tire portion.

3. The vehicle tire of claim 2, wherein the first fluid control member includes:
a pipe having an inlet/outlet hole structure through which air enters/exits the pipe;
an elastic body that is provided at a portion of the inside of the pipe; and
a sealing ball that is biased by the elastic body to an inlet hole to permit one-way air flow from the inlet hole to an outlet hole if air pressure outside the tire portion is higher than air pressure inside the tire portion, wherein the inlet hole is connected to the outside of the wheel and the outlet hole is connected to the air pressure check cylinder unit.

4. The vehicle tire of claim 3, wherein the outlet of the inlet/outlet hole structure is formed as a plurality of outlet holes.

5. The vehicle tire of claim 2, wherein the second fluid control member includes:
a pipe having an inlet/outlet hole structure through which air enters/exits the pipe;
an elastic body that is provided at a portion of the inside of the pipe; and
a sealing ball that is biased by the elastic body to an inlet hole to permit one-way air flow from the inlet hole to an outlet hole if the air pressure outside the tire portion is higher than the air pressure inside the tire portion, wherein the inlet hole is connected to the air pressure check cylinder unit and the outlet hole is connected to the inside of the tire portion.

6. The vehicle tire of claim 5, wherein the outlet of the inlet/outlet hole structure is formed as a plurality of outlet holes.

7. The vehicle tire of claim 5, wherein the air pressure check cylinder unit includes:
a cylinder connected to the outlet hole of the first fluid control member and the inlet hole of the second fluid control member;
a piston slidably inserted into the cylinder to move back and forth inside the cylinder; and
a return spring disposed in the cylinder and selectively compressed by the piston.

8. The vehicle tire of claim 7, wherein the piston includes:
a pushrod that extends outwards from the cylinder; and
a pushrod end that extends from an end of the pushrod and abuts an inner surface of the tire portion with a predetermined distance in a normal state to check the air pressure in the tire portion.

9. The vehicle tire of claim 1, wherein the fluid control member includes:
a pipe having an inlet/outlet hole structure through which air enters/exits the pipe;
an elastic body that is provided at a portion of the inside of the pipe; and
a sealing ball that is biased by the elastic body to an inlet hole to permit one-way air flow from the inlet hole to an outlet hole if an air pressure outside the tire portion is higher than an air pressure in the tire portion,
wherein at least one of the fluid control members includes the inlet hole connected to the outside of the wheel and the outlet hole connected to the air pressure check cylinder, and,
wherein at least one of the fluid control members includes an inlet hole connected to the air pressure check cylinder unit and an outlet hole connected to the inside of the tire portion.

10. The vehicle tire of claim 9, wherein the outlet of the inlet/outlet hole structure is formed as a plurality of outlet holes.

11. The vehicle tire of claim 1, wherein the air pressure check cylinder unit includes:
a cylinder connected to one of the fluid control member;
a piston slidably inserted into the cylinder to move back and forth inside the cylinder; and
a return spring disposed in the cylinder and selectively compressed by the piston.

12. The vehicle tire of claim 11, wherein the piston includes:
a pushrod that extends outward from the cylinder; and
a pushrod end that extends from an end of the pushrod and abuts an inner surface of the tire portion with a predetermined distance in a normal state to check the air pressure in the tire portion.
